(19) United States
(12) Patent Application Publication
(10) Pub. No.: US 2025/0270117 A1
(43) Pub. Date: Aug. 28, 2025

(54) WATER PROCESSING SYSTEM AND WATER PROCESSING METHOD

(71) Applicant: Yokogawa Electric Corporation, Tokyo (JP)

(72) Inventor: Yasuhiro MATSUI, Tokyo (JP)

(21) Appl. No.: 19/058,785

(22) Filed: Feb. 20, 2025

(30) Foreign Application Priority Data
Feb. 26, 2024 (JP) 2024-027005

(51) Int. Cl. C02F 1/44; C02F 1/66; C25B 1/04

(52) U.S. Cl. CPC C02F 1/441; C02F 1/444; C02F 1/66; C25B 1/04; C02F 2209/00

(57) ABSTRACT

A water processing system includes an ultrafiltration membrane device (UF membrane device), a reverse osmosis membrane device (RO membrane device), an electric deionization device (EDI device), and an information processing device (edge computer). The information processing device controls operations of the ultrafiltration membrane device, the reverse osmosis membrane device, and the electric deionization device based on information on a water electrolysis device that obtains hydrogen by subjecting water to electrolysis. Water that is processed by the electric deionization device is supplied to the water electrolysis device. The water electrolysis device is able to obtain hydrogen by subjecting supplied water to electrolysis.

### CROSS-REFERENCE TO RELATED APPLICATION(S)

The present application claims priority to and incorporates by reference the entire contents of Japanese Patent Application No. 2024-027005 filed in Japan on Feb. 26, 2024.

### FIELD

The preset disclosure relates to a water processing system and a water processing method.

### BACKGROUND

Desalinated seawater and tap water have been provided as pure water for electrolytic hydrogen (green hydrogen).

Patent Literature 1: Japanese Laid-open Patent Publication No. 2023-117843.

The conventional technique however has a problem that it is sometimes not possible to supply pure water for electrolytic hydrogen efficiently.

First, particularly in a water shortage, because tap water is used also for drinking water, it is sometimes difficult to keep tap water for electrolytic hydrogen. Furthermore, seawater desalination has a future problem in view of environmental conservation because, in addition to a high cost, seawater desalination causes a concentrated waste whose salinity is higher than that of seawater.

An object of the present disclosure is to supply pure water for electrolytic hydrogen efficiently.

### SUMMARY

According to an aspect of an embodiment, a water processing system includes an ultrafiltration membrane device, a reverse osmosis membrane device, an electric deionization device, and an information processing device, wherein the information processing device controls operations of the ultrafiltration membrane device, the reverse osmosis membrane device, and the electric deionization device based on information on a water electrolysis device that obtains hydrogen by subjecting water to electrolysis.

A water processing method that is executed by a water processing system including an ultrafiltration membrane device, a reverse osmosis membrane device, an electric deionization device, and an information processing device, the method includes, by the information processing device, controlling operations of the ultrafiltration membrane device, the reverse osmosis membrane device, and the electric deionization device based on information on a water electrolysis device that obtains hydrogen by subjecting water to electrolysis.

### BRIEF DESCRIPTION OF THE DRAWINGS

FIG. 1 is a diagram illustrating an entire configuration of a water processing system according to a first embodiment;

FIG. 2 is a functional block diagram illustrating a functional configuration of a supply system according to the first embodiment;

FIG. 3 is a functional block diagram illustrating a functional configuration of the water processing system according to the first embodiment;

FIG. 4 is a flowchart illustrating a flow of a process that a facility system executes;

FIG. 5 is a flowchart illustrating a flow of a process that a management system executes;

FIG. 6 is a flowchart illustrating a flow of a training process.

FIG. 7 is a diagram illustrating an architecture of a water processing system according to a second embodiment;

FIG. 8 is a diagram illustrating an architecture of a water processing system according to a third embodiment; and

FIG. 9 is a diagram illustrating a hardware configuration.

### DESCRIPTION OF EMBODIMENTS

Embodiments of a water processing system and a water processing method disclosed herein will be described in detail below with reference to the accompanying drawings. Note that the embodiments do not limit the disclosure. Note that the same components are denoted with the same reference numerals and redundant description will be omitted as appropriate. Each embodiment may be combined as appropriate in a scope without inconsistency.

### First Embodiment

### Entire Configuration (Architecture)

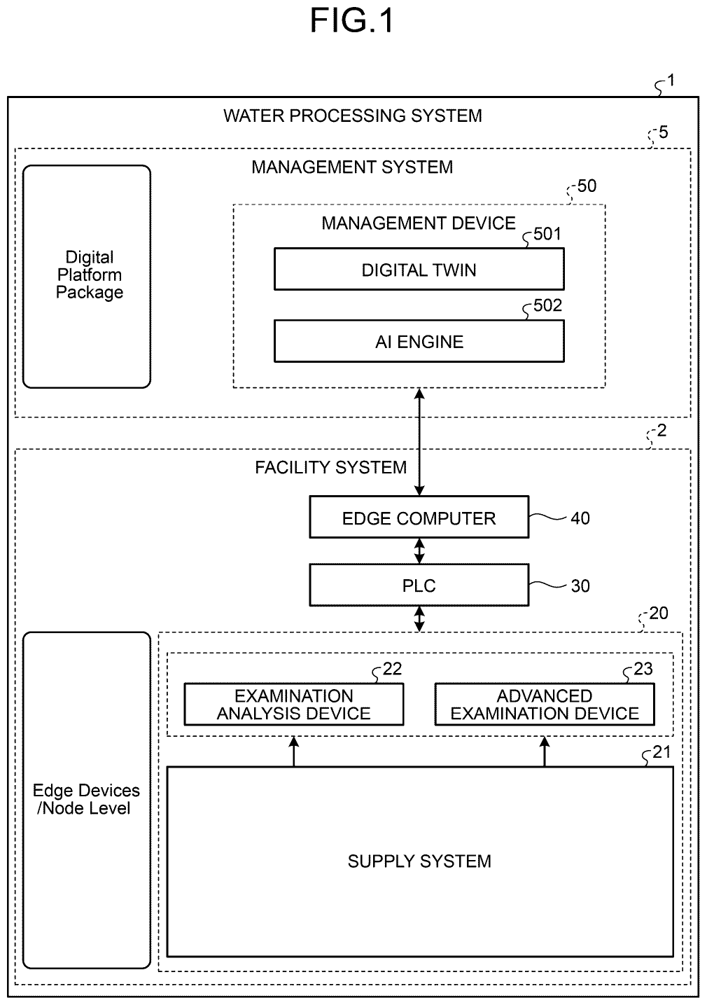

FIG. 1 is a diagram illustrating an entire configuration of a water processing system according to a first embodiment. A water processing system 1 illustrated in FIG. 1 is an example of a system that generates drinking water and pure water for electrolytic hydrogen from draining water, such as waste water and rainwater. Note that the pure water that is purified by the water processing system 1 may be ultrapure water. The water processing system 1 has two roughly classified categories. One is a management system 5 corresponding to a digital platform package and the other one is a facility system 2 corresponding to an edge device/node level configuring a real facility (real system).

The facility system 2 includes each water processing device that executes a water processing process and is connected to the management system 5 via a network N. Various networks, such as a dedicated line, a local area network (LAN), a virtual local area network (VLAN), or the Internet, can be employed as the network N.

The facility system 2 includes a water processing device group 20, a programmable logic controller (PLC) 30, and an edge computer 40 (an example of an information processing device). The water processing device group 20 includes edge devices at a level of nodes. The edge devices at the level of nodes include a supply system 21, an examination analysis device 22, and an advanced examination device 23. The devices are a module and are each controllable.

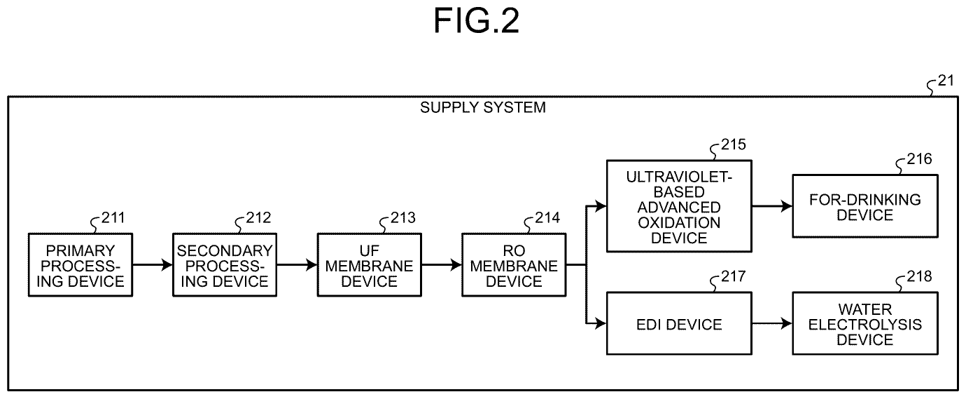

Using FIG. 2, a configuration of the supply system 21 will be described. FIG. 2 is a functional block diagram illustrating a functional configuration of a supply system according to a first embodiment.

The supply system 21 performs water processing on drained water, such as waste water and rainwater, and supplies drinking water (or domestic and commercial water) and green hydrogen. As illustrated in FIG. 2, the supply system 21 includes a primary processing device 211 and a secondary processing device 212. The supply system 21 includes an ultrafiltration membrane (UF membrane) device 213 and a reverse osmosis membrane (RO membrane) device 214. The supply system 21 includes an ultraviolet-based advanced oxidation device 215 and a for-drinking device 216. The supply system 21 includes an electric deionization (EDI) device 217 and a water electrolysis device 218.

The configuration of the supply system 21 illustrated in FIG. 2 is an example. For example, the supply system 21 need not include the primary processing device 211, the secondary processing device 212, the ultraviolet-based advanced oxidation device 215, and the for-drinking device 216.

The primary processing device 211 removes large solids, such as foreign substances contained in the drained water. The secondary processing device 212 removes organic substances that are not removed completely in primary processing using microorganisms (bacteria). The secondary processing device 212 performs, for example, activated sludge treatment, nitrification denitrification reaction treatment, etc.

The UF membrane device 213 and the RO membrane device 214 perform third processing. In the third processing, floating solids that are not removed completely in the secondary processing are removed by sand filtration or membrane filtration.

The UF membrane device 213 removes microorganisms and particulate matters from supplied water using filtration membranes. The UF membrane device 213 includes a plurality of UF membranes. The UF membrane device 213 performs membrane filtration on water that is supplied from the secondary processing device 212 using the UF membranes and removes microorganisms and particulate matters. The UF membrane device 213 supplies membrane-filtered permeable water (UF permeable water) after the membrane filtration to the RO membrane device 214.

The UF permeable water obtained by the UF membrane device 213 is supplied to the RO membrane device 214. The RO membrane device 214 removes impurities, such as ions and salts, from the UF permeable water. The RO membrane device 214 includes a RO membrane.

The ultraviolet-based advanced oxidation device 215 performs a UV-AOP (advanced oxidation process using ultraviolet rays) on the RO permeable water from the RO membrane device 214. The ultraviolet-based advanced oxidation device 215 thus performs oxidation decomposition on a small amount of chemical substances (for example NDMA) contained in the supplied water.

The for-drinking device 216 sterilizes the water that is supplied from the ultraviolet-based advanced oxidation device 215 with chlorine, or the like, and supplies drinking water (or domestic and commercial water).

The EDI device 217 removes ions from the water that is supplied from the RO membrane device 214 using ion exchange resin. The electrical conductivity of the water after the processing by the EDI device 217 is lower than that of the water that is supplied to the EDI device 217.

The EDI device 217 supplies water having an electrical conductivity that is associated with the water electrolysis device 218. A technical demand for supplied water is determined for the water electrolysis device 218. For example, the technical demand is that the electrical conductivity is 1 uS/cm (specific resistance of 1 MΩ·cm) or 0.05 uS/cm (specific resistance of 18.2 MΩ·cm). The EDI device 217 supplies water having an electrical conductivity corresponding to the technical demand.

The water electrolysis device 218 performs electrolysis on the water that is supplied from the EDI device 217 and obtains hydrogen. The hydrogen obtained by the water electrolysis device 218 is referred to as green hydrogen because CO2 is not discharged in the process.

The supply system 21 includes, in addition to mechanical devices not illustrated in the drawings, such as piping, a pump and a valve, measuring equipment necessary to control the quality of water, the amount of water, the pressure of water, etc. The measuring equipment is capable of measuring information on an amount of water, a pressure of water, and quality of water. The information on the amount, pressure, and quality of water includes a rate of rise in trans-membrane pressure deriving from fouling of the UF membrane and the RO membrane, a rate of rise in trans-module pressure deriving from stains in the RO membrane, a permeable water rate with respect to a drive pressure effective to membrane filtration (generally, an amount of water relative to an amount of permeable water per pressure unique to a membrane not in a fouled state: a specific rate of permeable water), a trans-membrane pressure after cleaning including chemical cleaning, a rate of recovery of the specific permeable-water rate, etc.

At least the UF membrane device 213, the RO membrane device 214, and the EDI device 217 among the devices of the supply system 21 may be housed in one container. The container includes piping that supplies water from the outside to the UF membrane device 213 and piping that discharges water that is supplied from the EDI device 217 to the outside. The container further includes measuring equipment that measures an amount, a pressure and quality of water permeating the UF membrane device 213.

As described above, housing the advanced water processing facility including the UF membrane device 213, the RO membrane device 214, and the EDI device 217 in the container reduces the work of maintenance and management, such as system updates and exchanges. It is also possible to exchange the advanced water processing facility in each container according to the entire performance of the water processing system 1.

The supply system 21 is a device (system) that performs physical or chemical water processing or these water processing processes. On the contrary, the examination analysis device 22 is a device that executes general examinations and analysis on pH, oxidation-reduction potential, electrical conductivity, turbidity, temperature of water, ultraviolet absorption luminosity, COD (Chemical Oxygen Demand), nitrogen (ammonia nitrogen, nitrate-nitrogen, and total nitrogen), residual chlorine, etc. The examination analysis device 22 has a function of measurement relating to mechanical process management (for example, turning on/off a pump or opening/closing a valve) and management of quality of operations (for example, an amount, a pressure, and quality of water) and transmitting and transferring an analog or digital signal. The advanced examination device 23 executes advanced examination and analysis on the water on which any one of or both filtration and sterilization have been performed by the supply system 21. The advanced examination device 23 is a device that executes PCR (Polymerase Chain Reaction), TOC (Total Organic Carbon), ATP (Adenosine Tri-phosphate), etc. The advanced examination device 23 has a function of measurement relating to management of quality of water that is safe to human bodies among the management of quality of operations and of transmitting and transferring an analog or digital signal.

The PLC 30 is an example of a computer that performs the above-described sequence control on each device at or under Level 0, Level 1, or Level 2. In the PLC 30, operations based on a time chart and start and stop and an operation sequence with respect to a given physical amount and a chemical index are defined. The PLC 30 executes various types of commands to each water processing device according to instructions from the edge computer 40 that is positioned at a higher level.

The edge computer 40 executes operational control on the water processing process in the facility system 2. For example, the edge computer 40 receives data, such as a status of control on the water processing process, content of control, the result of control, the status of processing, etc. The edge computer 40 executes simulations using the received data and prediction according to a machine learning model using the data and acquires a result of predicting a state of the water processing process, etc. The edge computer 40 then notifies the PLC 30 of the content of control in order to improve the water processing process, increase the quality, reduce the costs, and adjust the amount of production using the result of predicting the state of the water processing process.

The management system 5 is an example of a computer that controls the entire facility system 2, thereby controlling the water processing process and includes a system and software at a level of plant. The management system 5 includes a management device 50 and the management device 50 includes a digital twin 501 that generates a virtual module (virtual system) simulating a system configured at a level of a real facility. The management system 5 further includes an AI engine 502 that causes the digital twin to operate and controls the facility system 2 that is the real facility. Note that it is possible to realize the management system 5 by a physical machine including a memory and a processor, cloud computing, or the like. The management device 50 can be realized by a physical machine or can be realized by a virtual machine using virtual technologies and a container.

The digital twin 501 collects various types of information from the facility system 2 in a physical space and each device and reproduces the physical space in a virtual space using the collected various types of information. In other words, the digital twin 501 virtually configures the virtual system that simulates the same variation as that in the facility system 2 that is the real facility. The virtual system that the digital twin 501 simulates consists of elements of each of the water processing devices, a virtual terminal device obtained by combining the elements, and the virtual module. The virtual module consists of virtual water processing devices corresponding to the respective water processing devices of the facility system 2 that is the real facility.

In the virtual system, it is possible to, based on data on the real facility that is collected previously and data that is sent sequentially from the real facility, set and update a parameter that makes it possible to directly or indirectly calculate causal connections of inputs and outputs with respect to the virtual terminal devices and the virtual module. Setting and updating the parameter are executed by the AI engine 502 to be described below.

The digital twin 501 is also able to form a virtual system by freely combining virtual water processing devices of the module or modules virtually.

The AI engine 502 not only causes the virtual system on the digital twin 501 to have the configuration simulating the real facility but also collate the module consisting of the individual virtual water processing devices and the virtual module. Accordingly, the AI engine 502 is able to derive virtual operation conditions optimum to various environments and calculate input and output values. The AI engine 502 outputs the optimum virtual operation conditions and the input and output values and makes a notification to the edge computer 40 to execute updating the parameter.

In the virtual system that is realized by the digital twin 501, the AI engine 502 simulates sudden variation in the virtual system and specifies an optimum configuration in the system. The AI engine 502 outputs a change to the optimum configuration in the system to a manager, or the like, and updates the parameter that the edge computer 40 uses for simulations, or the like.

The AI engine 502 is also able to use a machine learning model using deep learning, or the like. Note that the management device 50 may be realized using a cloud system and may be arranged in a module. The management device 50 may have a function of displaying a schematic view illustrating the configuration of the virtual system, a schematic view illustrating the configuration of the real system, and input and output values and parameters of each water processing device, each module, each virtual water processing device, and each water processing module.

### Functional Configuration of Water Processing System 1

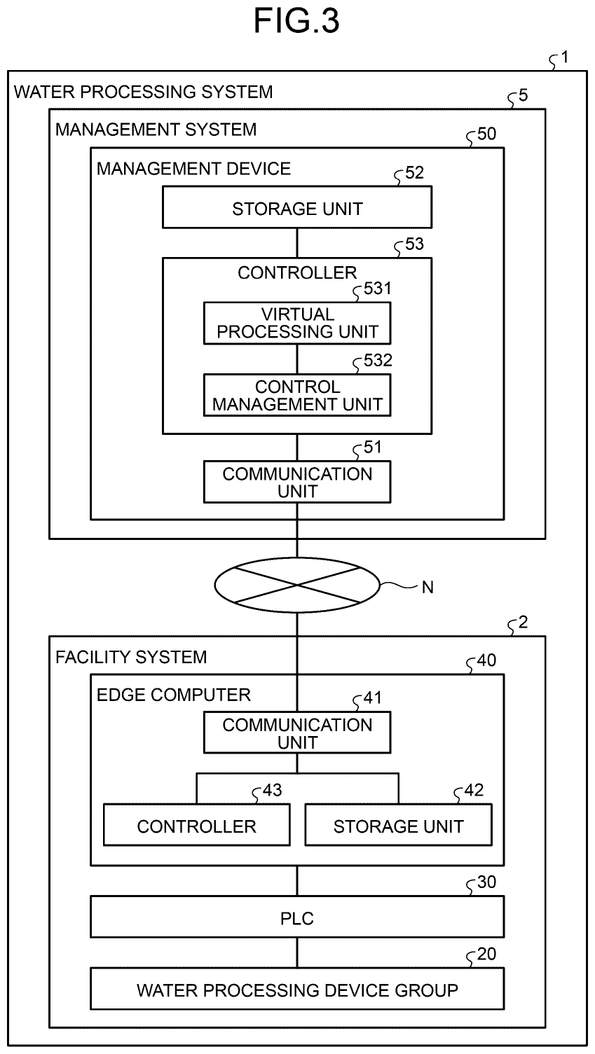

FIG. 3 is a functional block diagram illustrating a functional configuration of the water processing system 1 according to the first embodiment. As illustrated in FIG. 3, the water processing system 1 includes the facility system 2 and the management system 5.

### Configuration of Facility System 2

The facility system 2 is a system that executes the water processing process and includes the water processing device group 20, the PLC 30, and the edge computer 40. The facility system 2 does not have a layered functional system configuration but forms a module that includes the individual water processing devices and the edge computer 40 and that performs minimum operational control. The module may be arranged and have a combined configuration such that the module is controllable directly by the management system 5 (digital platform package).

The water processing device group 20 includes each water processing device that executes a water processing process including filtration, sterilization, piping, and measurement. For example, the water processing device group 20 includes membranes UF-RO 20a, UVAOP Ozone 20b, Mechanical components 20c, control H&S 20d. Note that the individual water processing devices can be arranged freely in the module, for example, the water processing devices are combined in parallel or in series or a plurality of water processing devices are arranged. Furthermore, the module may include not only a water processing device but also an analysis device capable of sampling and analyzing quality of water and performance.

The PLC 30 is an example of a device that executes various types of commands to each device in the water processing device group 20 and sequence control. For example, the PLC 30 executes various types of control on each water processing device according to a logic (control logic) that includes control, such as PID, and that is determined at the stage of designing the water processing system 1 and the stage of starting operations. For example, the PLC 30 executes various types of control on the water processing process, such as changing the temperature of water, controlling opening/closing the valve, and controlling the amount of water. The PLC 30 transmits the results (device information) to the edge computer 40.

The PLC 30 executes correction, addition, change, and deletion of a logic, or the like, according to an instruction from the edge computer 40 that is positioned at a higher level. The PLC 30 executes various types of control, such as changing the temperature of water, controlling opening/closing the valve, and controlling the amount of water.

The edge computer 40 is an example of a device that executes operational control on the water processing process in the facility system 2 based on the results of operations of the respective water processing devices that are executed in each control on the water processing process. The edge computer 40 includes a communication unit 41, a storage unit 42, and a controller 43.

The communication unit 41 is a processing unit that controls communication with another device and, for example, is realized using a communication interface. For example, the communication unit 41 receives data on the water processing process, such as a state and a result of control, from each water processing device in the water processing device group 20 and receives various types of data from the management device 50. The communication unit 41 transmits various types of data containing control commands to the PLC 30 and transmits various types of data on the water processing process and various types of data on control of the PLC 30 to the management device 50.

The storage unit 42 is an example of a processing unit that stores various types of data, a program that the controller 43 executes, etc., and is realized using, for example, a memory and a hard disk.

The controller 43 is a processing unit in charge of the entire edge computer 40 and is realized using, for example, a processor, or the like. Specifically, using device information on an operational status of each water processing device in the facility system 2 that the controller 43 belongs, the controller 43 executes optimization of the water processing process in the facility system 2 that the controller 43 belongs.

For example, information indicating whether a normal operation is being performed with respect to each water processing device, content of a process according to the current setting values (for example, the amount of water, the temperature, and the degree of opening and closing of the valve) with respect to each water processing device, and information containing content of control ordered by the PLC 30 with respect to each water processing device are taken as an example of the device information.

The controller 43 generates a first condition that relates to the water processing process in the facility system 2 based on each set of device information. Thereafter, the controller 43 outputs execution of processing and a change of the processing, etc., to the PLC 30 according to the first condition. Note that an example of the first condition includes an operation condition that is within a scope of a specification according to a condition of a client at the stage of designing the facility system 2 and that is controllable in the facility system 2, such as the quality of water, the time of sterilization, and the production.

Specifically, for example, the controller 43 acquires the status of the water processing process, an operational status of each water processing device, etc., are acquired from each water processing device. The controller 43 acquires a result of execution of the logic, or the like, by the PLC 30 from the PLC 30. Using each set of acquired data, the controller 43 then executes a simulation or executes a prediction using the machine learning model and acquires a result of prediction of items that are specified previously, such as a state of the water processing process, a risk, and costs. Thereafter, according to the result of prediction, the controller 43 executes a change of the content of control on the PLC 30.

More specifically, the controller 43 increases the opening of the valve in order to increase the production when it is predicted that the production will decrease. Alternatively, the controller 43 grasps a projection that the performance requested to the membrane, pump, and measuring equipment will not be met and outputs an alarm. Furthermore, the controller 43 puts a basic cleaning sequence relating to membrane cleaning in action in order to maintain or improve the performance. For example, when there is a tendency of fouling of the membrane, the controller 43 analyzes optimization of conditions relating to frequency of performing cleaning relating to the cleaning sequence and the concentration of a chemical, or the like, and makes a shift to an improved cleaning sequence aimed at increasing an effect of cleaning and maintaining the production.

In other words, the controller 43 (the edge computer 40) is able to execute control for optimized operations of the water processing system 1 in order to maintain the production and perform a cost reduction and stable operations within the range of the specification that is determined previously when the inside of the facility system 2 is designed.

The controller 43 executes optimization of the water processing process in the facility system 2 to which the controller 43 belongs according to an instruction from the management system 5, thereby making it possible to execute a change or addition of the logic that the PLC 30 has, and the like. For example, the controller 43 adds a logic that increases the amount of water, or the like, in order to increase the production, changes a threshold of temperature abnormality that is set in the existing logic, or the like, to a new threshold that is set newly on the side of the management system 5, or deletes part of the logic, or the like, in order to reduce the costs.

In other words, according to an instruction from the management system 5, the controller 43 (the edge computer 40) is able to execute control for optimum operations of the water processing system 1 beyond the scope of the specification that is determined previously when the inside of the facility system 2 is designed. Needless to say, it is an example only and instructions from the management system 5 may be within the scope of the specification that is determined previously when the inside of the facility system 2 is designed.

### Configuration of Management System

As illustrated in FIG. 3, the management system 5 includes a management device 50 that is realized using a physical machine or a virtual machine. The management device 50 includes a communication unit 51, a storage unit 52, and a controller 53.

The communication unit 51 is a processing unit that controls communication with another device and, for example, is realized using a communication interface, or the like. For example, the communication unit 51 receives content of control by the PLC 30 and various types of data occurring in the facility system 2 from the edge computer 40. The communication unit 51 also transmits various types of data generated by the controller 53 to the edge computer 40.

The storage unit 52 is an example of a processing unit that stores various types of data, a program that the controller 53 executes, etc., and is realized using, for example, a memory and a processor.

The controller 53 is a processing unit in charge of the entire management device 50 and is realized using, for example, a processor, or the like. Specifically, the controller 53 includes a virtual processing unit 531 and a control manager 532 and executes operational control on the water processing process in the facility system 2 via the edge computer 40.

The virtual processing unit 531 is a processing unit that acquires data on an operational status of the water processing process in the facility system 2 from the edge computer 40 and that executes a simulation of the water processing process using each water processing device that is virtualized using a virtualization technology and acquired data. In other words, the virtual processing unit 531 corresponds the digital twin 501 in FIG. 1 and virtually configures a virtual system that simulates the same variation as that of the facility system 2 that is the real system.

The control manager 532 is a processing unit that executes control on the processing process in the facility system 2 via the edge computer 40. Specifically, the control manager 532 corresponds to the AI engine 502 in FIG. 1 and executes a simulation by the virtual processing unit 531 when a change in the specification of the facility system 2, a change in the request, a change in the demand for the total amount of water to be generated, or the like, occurs. Based on the result of the simulation, the control manager 532 executes changing the logic that is currently executed by the PLC 30, or the like.

For example, the control manager 532 acquires process information on an operational status of the water processing process from the edge computer 40 of the facility system 2 and, based on the acquired process information, generates content of control that optimizes the entire facility system 2. The control manager 532 outputs the content of control to the edge computer 40 of the facility system 2. Note that examples of the process information includes content of control that is ordered by the edge computer 40 to the PLC 30, a status of execution of the water processing process that is executed according to the content of control, and content of a simulation that is executed by the virtual processing unit 531 (the digital twin 501).

The control manager 532 is capable of executing various types of predictions on the water processing process in the facility system 2 using a trained machine learning model, or the like, as an example of optimization. For example, the control manager 532 generates a second condition that relates to the water processing process using various types of data that is acquired, generated, and simulated by the virtual processing unit 531 (the digital twin 501). The control manager 532 notifies the edge computer 40 of the content of control according to the second condition. As a result, the edge computer 40 executes changing the content of control, or the like, via the PLC 30.

The second condition includes content of operations according to the information that is specified from the outside of the facility system 2. For example, when it is out of the scope of the specification of the facility system 2 and a change in the specification of the client occurs or a suggestion of an improvement to the client containing costs is made, the control manager 532 executes a simulation using the virtual processing unit 531 (the digital twin 501). Thereafter, when the client, or the like, approves the result of the simulation, the control manager 532 outputs an instruction to change the logic, or the like, and a changed logic to the edge computer 40 according the result of the simulation.

### Flow of Process

An example of a flow of a process that is executed by the facility system 2 and an example of a flow of a process that is executed by the management system 5 will be described next.

### Process Performed by Facility System 2

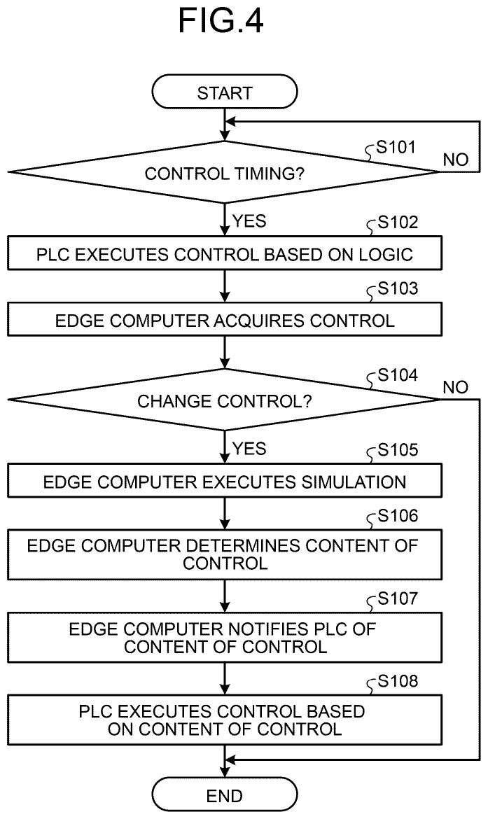

FIG. 4 is a flowchart illustrating the flow of the process that the facility system 2 executes. As illustrated in FIG. 4, when predetermined control timing is reached (Yes at S101), the PLC 30 executes control on the water processing process based on a logic that has been set, or the like (S102). The edge computer 40 then acquires the result of the control by the PLC 30 (S103) and, based on the result of the control by the PLC 30, detects abnormal detection or occurrence of a deviation from a normal value, or the like, and determines whether to change the control (S104).

On determining that a control change is necessary (Yes at step S104), the edge computer 40 executes a simulation, or the like, (S105) and determines content of control that is executed as a countermeasure (S106).

The edge computer 40 notifies the PLC 30 of the content of control (S107) and, based on the content of control, makes a change in the logic that is set, or the like, and executes control on the water processing process (S108).

### Process Performed by Management System 5

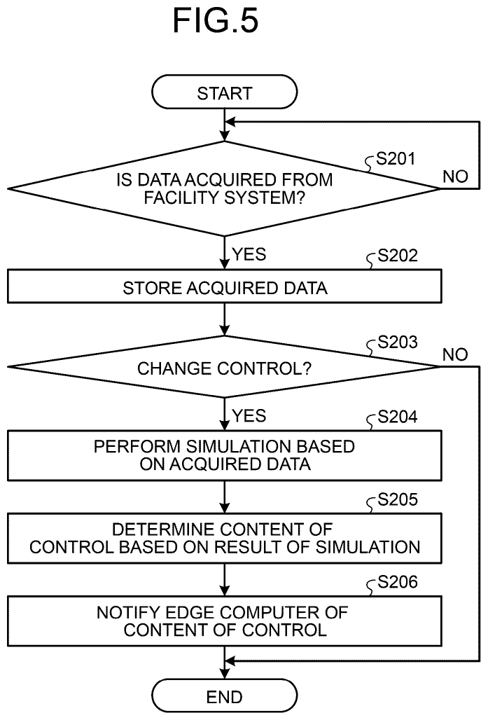

FIG. 5 is a flowchart illustrating the flow of the process that the management system 5 executes. As illustrated in FIG. 5, on acquiring data on the state and the result of the process that relate to the water processing process from the facility system 2 via the edge computer 40 (Yes at S201), the management system 5 stores acquired data (S202).

When a control change including a change in the demand, a change in the setting, a change in the request, and an abnormal state occurs (YES at S203), the management system 5 executes a simulation by the virtual system of the water processing process that is generated by the virtual processing unit 531 (the digital twin 501) (S204).

Thereafter, using the table in which the simulation result and a change in the design, or the like, are associated, the management system 5 determines content of control for making an improvement of the water processing process of the facility system 2 or a change in the design (S205).

The management system 5 notifies the edge computer 40 of the facility system 2 of the content of control (S206). As a result, the edge computer 40 executes changing the logic of the PLC 30 and the PLC 30 executes the process according to the new logic, or the like, thereby executing a change in the water processing process. Note that the management system 5 is able to output the content of control that is generated according to the simulation, or the like, to the management device, a display, etc.

The edge computer 40 controls operations of the UF membrane device 213, the RO membrane device 214, and the EDI device 217 based on the information on the water electrolysis device 218 that obtains hydrogen by subjecting water to electrolysis.

The edge computer 40 further is able to control operations of the UF membrane device 213, the RO membrane device 214, and the EDI device 217 based on the information on the RO membrane device 214. For example, the edge computer 40 performs control based on the information that is acquired by the above-described measuring equipment. Specifically, the edge computer 40 controls the UF membrane device 213, the RO membrane device 214, and the EDI device 217 based on physical chemical indices including quality of water that is supplied to the RO membrane device 214, a trans-module pressure that occurs in the RO membrane device 214, a trans-membrane pressure, a specific permeable-water rate, and a demineralization rate and an amount of load based on an amount and a pressure of water that is supplied to the RO membrane device 214.

The edge computer 40 optimizes control on the UF membrane device 213, the RO membrane device 214, and the EDI device 217 (the pressure, the amount of water, and the quality of water) while receiving a necessary amount of pure water that is requested on the side of the water electrolysis device 218. In optimization, the edge computer 40 measures an amount of control on each device to reduce fouling. Specifically, through optimization of a chemical to be injected and chemical cleaning and a sequence of implementing the cleaning (implementation schedule and a density of a chemical to be used), the edge computer 40 reduces the load on and depletion of the membranes, thereby reducing the operation costs.

Providing the UF membrane device 213 before the RO membrane device 214 reduces the load of the RO membrane device 214 and extends the life. The UF membranes that the UF membrane device 213 includes has pores having a diameter between 0.01 micron and 0.1 micron. The UF membrane has pores with a fine diameter, which makes it possible to reduce frequency of chemical cleaning (cleaning in place (CIP)) of the RO membrane of the RO membrane device 214 (for example, about four times).

Furthermore, in order to reduce the frequency of implementing CIP, the edge computer 40, for example, optimizes an amount of injection of a chemical that is injected into the RO membrane device 214 and an injection sequence (concentration, injection schedule). For example, the drug that is injected is any one of or a combination of an anti-scale agent, combined chlorine, and a pH adjuster.

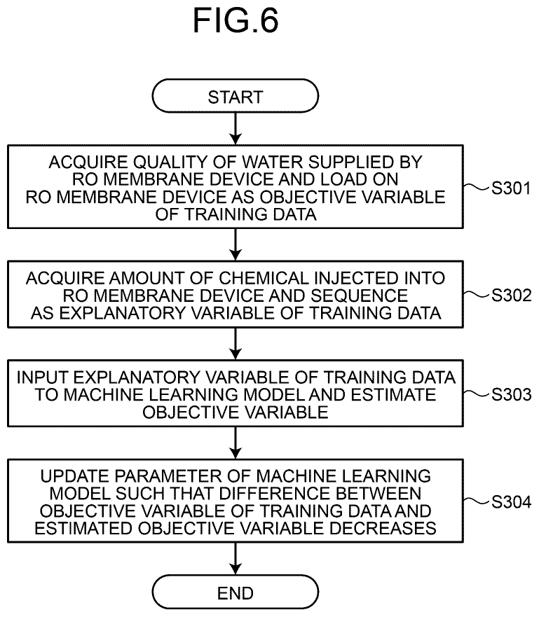

The edge computer 40 is able to optimize an amount of a chemical that is injected into the RO membrane device 214 and an injection sequence. Using FIG. 6, a process of training the machine learning model will be described. FIG. 6 is a flowchart illustrating a flow of the training process.

As illustrated in FIG. 6, first of all, the edge computer 40 acquires, as an objective variable of training data, quality of water that is supplied by the RO membrane device 214 and a load on the RO membrane device 214 (step S301).

For example, quality of water includes a temperature of supplied water and electrical conductivity of permeable water. The load includes a pressure of water supplied to the RO membrane, a pressure that is sensed from concentrated water, trans-membrane and trans-module pressures, an osmotic pressure deriving from concentration polarization, and a risk of deposition of deposited components that is calculated according to a concentration polarization phenomenon.

Next, the edge computer 40 acquires, as an explanatory variable of the training data, an amount of a chemical that is injected into the RO membrane device 214 and a sequence (step S302).

The edge computer 40 inputs the explanatory variable of the training data to the machine learning model and estimates an objective variable (step S303). For example, the machine learning model is a neural network.

The edge computer 40 updates the parameter of the machine learning model such that a difference between the objective variable of the training data and the estimated objective variable decreases (step S304). For example, the edge computer 40 updates a parameter, such as a weight on the neural network, by back propagation.

The edge computer 40 optimizes the amount of the chemical that is injected into the RO membrane device 214 and the sequence using the machine leaning model that is trained using, as training data, the quality of water that is supplied by the RO membrane device 214 and the load on the RO membrane device 214. For example, based on the result of estimation by the machine learning model that has been trained, the edge computer 40 controls operations such that the amount of the chemical injected and the sequence of injection are at minimum in a range where the load on the RO membrane device 214 is allowable.

The demineralization rate of the RO membrane of the RO membrane device 214 is determined by an electrical conductivity of RO permeable water that is requested. For example, the requested electrical conductivity of the RO permeable water is 10 nS/cm or lower, the RO membrane device 214 includes an RO membrane such that the demineralization rate is 99% or higher. For example, the configuration of the RO membrane is determined by a type of the RO membrane, the number of membranes, and arrangement of membranes (a stage and a path configuration). For example, the configuration of the RO membrane device 214 is determined by increasing the number of membranes until the measured demineralization rate is 99% or higher after only a given number of predetermined types of RO membranes are arranged according to given membrane arrangement.

Optimization of the amount of the chemical injected into the RO membrane device 214 and the sequence will be described. Optimization in principle keeps operations under a given condition according to a mass balance (an amount of water, a pressure of water, and a load with respect to water quality that are assumed per stage or path at the time of designing) that is assumed by calculation. On the other hand, a progress in fouling or stains in the RO membrane, aging of the RO membrane, and furthermore a variation in the load with respect to water quality of water that is supplied to the RO membrane and that is processed make it is difficult to meet the mass balance in design. In such a case, increasing the pressure or varying the mass balance distributes and reduces the load on the arranged RO membrane and optimizes a membrane filtration operation for maintaining the demineralization rate at 99% or higher. It is effective to stop the membrane filtration operation temporarily and perform chemical cleaning in order to eliminate the fouling and stains of the RO membrane to avoid a damage to the membrane and the system due to a pressure increase and an operational cost increase. This chemical cleaning scheme (timing of implementation, a type of a used chemical, a concentration, a time of immersion) is determined at the time of designing. Using the trained machine learning model, the edge computer 40 calculates optimization of a mass balance effective to reduce the cost and the chemical cleaning scheme at the time of the above-described RO membrane filtration and realizes RO membrane filtration and chemical cleaning that are more efficient compared to behaviors in design.

### Effect

According to the water processing system, it is possible to efficiently supply pure water for electrolytic hydrogen (green hydrogen) from processed waste water. For example, in drought-affected regions with poor alternative water sources (for example, Australia and U.S.A.), obtaining pure water by seawater desalination costs high and there are concerns about the effects on the environment because concentrated draining water whose salinity is high. In the drought-affected regions, because of consideration that drinking water and domestic and commercial water are prioritized in supplying tap water, it is sometimes difficult to use tap water for green hydrogen. According to the first embodiment, utilizing processed waste water for green hydrogen (electrolytic hydrogen) solves such a problem.

As described above, the water processing system 1 according to the first embodiment is able to flexibly install more modules for a request for installing more devices according to a demand. The water processing system 1 is not dependent on the configuration of the water processing device and is able to divert data that is collected from individual water processing devices that are used in various water processing facilities, which makes it possible to realize optimum control.

By utilizing the edge computer 40 and performing management at the level of modules, the water processing system 1 is able to instantaneously calculate a module or a combination to run regardless of experiences, and the like, and makes a suggestion automatically. By simulating a method of coping with unexpected environmental changes on a virtual system in a facility with less environmental changes, the water processing system 1 is able to estimate input and output values without performing tests in a real facility.

### Second Embodiment

In the first embodiment, the example where the single edge computer 40 controls the entire water processing device group 20 via the PLC 30 in the facility system 2 has been described; however, embodiments are not limited to this. For example, it is also possible to set an edge computer in each water processing device in the water processing device group 20 to enable the management system 5 to control the water processing devices individually. In a second embodiment, an example where the management system 5 directly controls each of the water processing devices and a module configured in a real facility will be described.

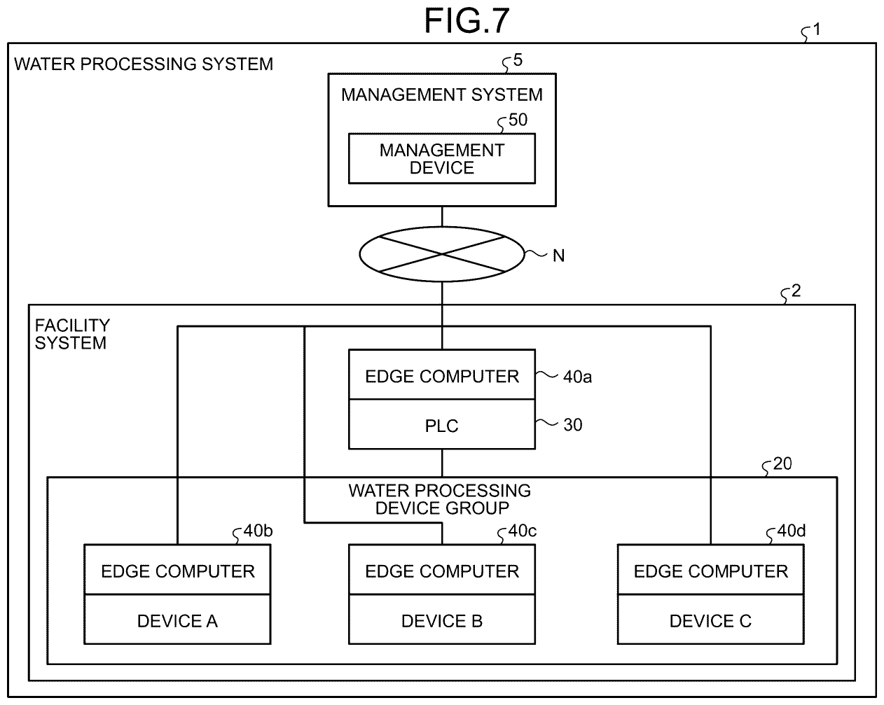

FIG. 7 is a diagram illustrating an architecture of the water processing system 1 according to the second embodiment. As illustrated in FIG. 7, the water processing system 1 according to the second embodiment includes the facility system 2 and the management system 5 as in the first embodiment.

The second embodiment is different from the first embodiment in that Device A, Device B, Device C, and Device C are provided with edge computers 40a, 40b, 40c, and 40d, respectively. The edge computers 40a, 40b, 40c, and 40d have the same function as that of the edge computer 40 described in the first embodiment.

For example, the management system 5 acquires data, such as the state of the PLC 30 or each of the water processing devices, the status of control, and the result of control, from each of the edge computers 40a, 40b, 40c, and 40d. Using a virtual system and an AI (a machine learning model), or the like, the management system 5 generates content of control on operations of each of the water processing devices. The management system 5 notifies each of the edge computers 40a, 40b, 40c and 40d of the generated content of control.

As a result, each of the edge computers 40a, 40b, 40c and 40d executes control according to the content of control of which notification is made by the management system 5. As described, by directly controlling a water processing device in the minimum unit in each module, the management system 5 (an AI engine 502) is able to perform more optimum control speedily.

The management system 5 is able to obtain a solution that optimizes the entire processing system, thus enables optimum operations in each water processing device using each edge computer configuring the module, and enables a combination of modules. The management system 5 is also able to transmit commands directly to the water processing devices and therefore increases the rate of operations on the water processing devices. It is also possible to increase freedom in combining the water processing devices, increase freedom in combining parameters, and consider causal connections between terminal devices. The management system 5 is able to derive a countermeasure against unexpected changes appropriately and speedily.

### Third Embodiment

In the first embodiment or the second embodiment, the example where the single management system 5 manages and controls the single water processing system (the facility system 2) has been described; however, embodiments are not limited to this. For example, the single management system 5 manages, as one single water processing device, an integrated system obtained by combing a plurality of water processing devices, thereby controlling the entire water processing system comprehensively.

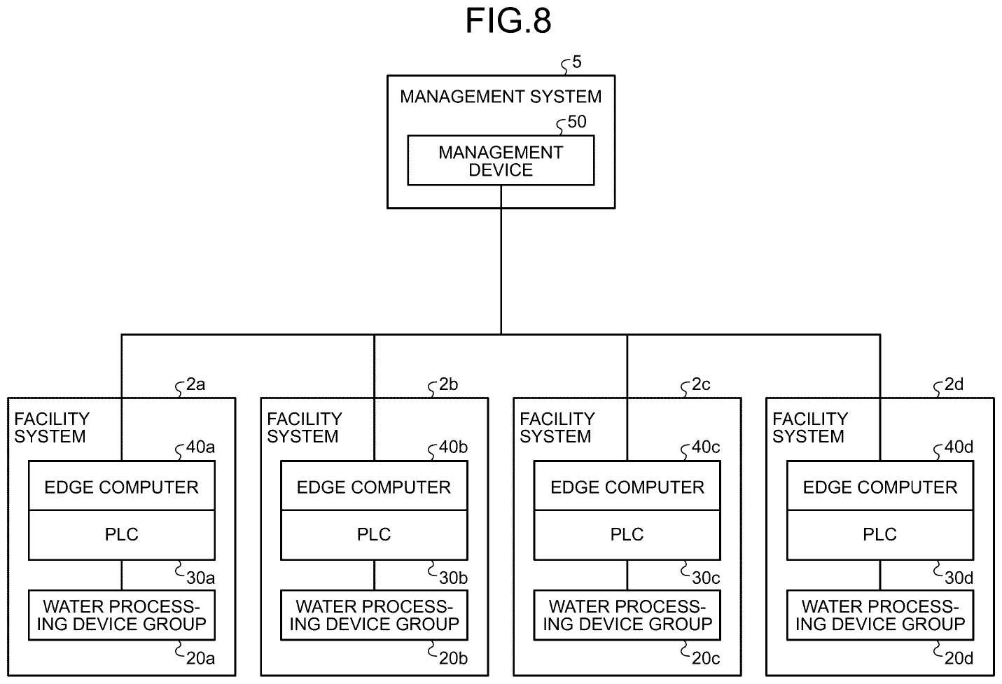

FIG. 8 is a diagram illustrating an architecture of the water processing system 1 according to a third embodiment. As illustrated in FIG. 8, the water processing system 1 according to the third embodiment includes the management system 5 and a plurality of facility systems 2a, 2b, 2c, and 2d.

The management system 5 has the same function as that of the management system 5 described in the first embodiment and each of the facility systems 2a, 2b, 2c, and 2d has the same function as that of the facility system 2 described in the first embodiment.

The facility system 2a includes the water processing device group 20a, a PLC 30a, and the edge computer 40a and the facility system 2b includes a water processing device group 20b, a PLC 30b, and an edge computer 40b. The facility system 2c includes a water processing device group 20c, a PLC 30c, and an edge computer 40c and the facility system 2d includes a water processing device group 20d, a PLC 30d, and an edge computer 40d.

The water processing device group 20a, 20b, 20c, and 20d have the same configuration as the water processing device group 20 described in the first embodiment. The PLCs 30a, 30b, 30c and 30d have the same function as the PLC 30 described in the first embodiment. The edge computers 40a, 40b, 40c and 40d have the same function as that of the edge computer 40 described in the first embodiment.

In such a configuration, the management system 5 collects data from not only one water processing system but also from a plurality of water processing systems. For example, the management system 5 acquires various types of data on the water processing process from each of the facility systems 2a, 2b, 2c and 2d. Based on the operational status of the water processing process of each of the facility systems, the management system 5 generates content of control on an integrated operational index of the facility systems. Thereafter, according to the content of control, the management system 5 executes the operational control on the water processing process that each edge computer of each facility system executes.

For example, assume a water processing system in which each of the facility systems 2 are asset in the same region. In such a state, even when an instruction to increase the production of the entire system is made, the management system 5 is able to make a change to content of control that increases the occupancy rate of the facility system 2b with a space in productivity. As a result, the management system 5 is able to distribute the load on the entire water processing system and thus is able to avoid a risk that is associated with stopping any one of the water processing systems.

In the above-described state, even when an instruction to increase the productivity of the facility system 2a is made, the management system 5 is able to make a change to content of control that increases the occupancy rate of the facility system 2c with the smallest operational cost. As a result, the management system 5 is able to realize an increase in productivity while executing a cost reduction over the water processing system.

The management system 5 is able to collect the operational status of each of the facility systems 2, a facility investment, costs, and the like, and perform integrated management. As a result, the management system 5 is also able to suggest using another facility system to a client when the operational load on a facility system is extremely high.

The management system 5 manufactures the facility system 2a and the facility system 2b that meet a request of the client and executes the water processing process. Thereafter, even when the need to generate a new facility system arises in association with a change in the request of the client, the management system 5 is able to deal with the request of the client while reducing the cost of generating a new system by suggesting use of the facility system 2d having the same configuration.

As described above, the water processing system 1 according to the third embodiment is able to repurpose data that is collected from a plurality of water processing systems regardless of the individual water processing systems (facility systems).

### Fourth Embodiment

The embodiments of the disclosure have been described and the disclosure may be carried out in various different modes.

### Numerical Values, etc.

The number of water processing devices, the number of facility systems, and the specific example of content of control are an example only and are changeable freely. Also as for the flowcharts described in the embodiments, it is possible to change the order of processes in a scope without inconsistency.

### System

The process procedure, control procedure, specific names, and information including various types of data and parameters that are presented in the description above and the drawings are changeable freely unless otherwise noted. For example, the water processing system 1 may be configured such that a real facility automatically simulates a virtual system configuration that is calculated by the management system 5 and that is optimized.

Each component of each device illustrated in the drawings is a functional idea and need not necessarily be configured physically as illustrated in the drawings. In other words, specific modes of distribution and integration of devices are not limited to those illustrated in the drawings. In other words, all or part of the devices can be configured by functional or physical distribution or integration in any unit according to various types of load and usage.

Furthermore, all or given part of each processing function implemented by each device can be realized by a central processing unit (CPU) or a program that is analyzed and executed by the CPU or can be realized as hardware according to a wired logic.

### Hardware

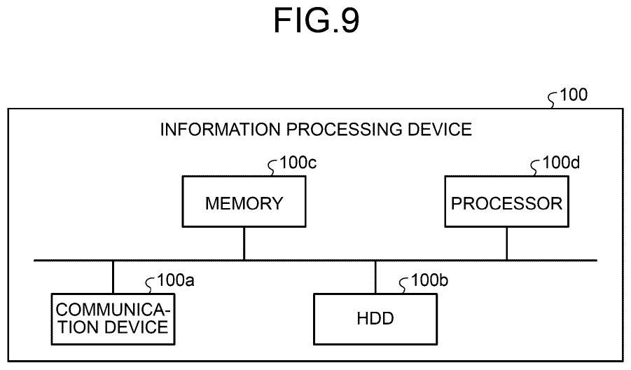

An example of a hardware configuration of the computer described in the embodiments will be described next. Note that the management device 50 and the edge computer 40 have similar hardware configurations and thus are described as an information processing device 100 here. FIG. 9 is a diagram illustrating a hardware configuration example. As illustrated in FIG. 9, the information processing device 100 includes a communication device 100a, a hard disk drive (HDD) 100b, a memory 100c, and a processor 100d. The units illustrated in FIG. 9 are connected mutually by a bus, or the like.

The communication device 100a is a network interface card, or the like, and communicates with another server. The HDD 100b stores a program that implements the functions illustrated in FIG. 3 and a DB to run and data.

The processor 100d reads the program that executes the same process as that of each of the processing units illustrated in FIG. 3 from the HDD 100b, or the like, and loads the program in the memory 100c, thereby running the process that executes each of the functions illustrated in FIG. 3, etc. For example, the management device 50 is exemplified and described. The process executes the same function as that of each of the processing units that the management device 50 includes. Specifically, the processor 100d reads a program with the same functions as those of the virtual processing unit 531, the control manager 532, etc., from the HDD 100b. The processor 100d then executes processes that implement the same processes as those of the virtual processing unit 531, the control manager 532, etc.

As described above, the information processing device 100 operates as an information processing device that executes a water processing method by reading and executing the program. The information processing device 100 may read the above-described program from a recording medium using a medium reading device and execute the read program, thereby implementing the same functions as those of the above-described embodiments. Note that programs according to other embodiments are not limited to being executed by the information processing device 100. For example, the present disclosure is similarly applicable to the case where another computer or another server executes the program or the computer and the server execute the program cooperatively.

The program can be distributed via a network, such as the Internet. The program can be recorded in a computer-readable recording medium, such as a hard disk, a flexible disk (FD), a CD-ROM, a MO (Magneto-Optical disk), or a DVD (Digital Versatile Disc), can be read by a computer from the recording medium, and thus can be executed.

According to an embodiment, it is possible to supply pure water for electrolytic hydrogen efficiently.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A water processing system comprising an ultrafiltration membrane device, a reverse osmosis membrane device, an electric deionization device, and an information processing device, wherein the information processing device controls operations of the ultrafiltration membrane device, the reverse osmosis membrane device, and the electric deionization device based on information on a water electrolysis device that obtains hydrogen by subjecting water to electrolysis.

2. The water processing system according to claim 1, wherein the information processing device controls operations of the ultrafiltration membrane device, the reverse osmosis membrane device, and the electric deionization device further based on information on the reverse osmosis membrane device.

3. The water processing system according to claim 2, wherein the information processing device controls operations of the ultrafiltration membrane device, the reverse osmosis membrane device, and the electric deionization device based on physical chemical indices including quality of water that is supplied to the reverse osmosis membrane device, a trans-module pressure that occurs in the reverse osmosis membrane device, a trans-membrane pressure, a specific permeable-water rate, and a demineralization rate and an amount of load based on an amount of and a pressure of water that is supplied to the reverse osmosis membrane device.

4. The water processing system according to claim 1, wherein the ultrafiltration membrane device supplies filtered water to the reverse osmosis membrane device, and
the information processing device optimizes an amount of a chemical that is injected into the reverse osmosis membrane device and a sequence.

5. The water processing system according to claim 4, wherein the information processing device optimizes the amount of the chemical that is at least any one of an anti-scale agent, combined chlorine, and a pH adjuster that is injected into the reverse osmosis membrane device and the sequence.

6. The water processing system according to claim 4, wherein the information processing device optimizes the amount of the chemical that is injected into the reverse osmosis membrane device and the sequence using a trained machine learning model using, as an input, physical chemical indices including quality of water that is supplied to the reverse osmosis membrane device, a trans-module pressure that occurs in the reverse osmosis membrane device, a trans-membrane pressure, a specific permeable-water rate, and a demineralization rate and an amount of load based on an amount of and a pressure of water that is supplied to the reverse osmosis membrane device.

7. The water processing system according to claim 6, wherein the information processing device optimizes the amount of the chemical that is injected into the reverse osmosis membrane device and the sequence using the trained machine learning model that outputs an amount of a chemical that is injected to the reverse osmosis membrane device and a sequence.

8. The water processing system according to claim 1, wherein the reverse osmosis membrane device includes an RO membrane such that a demineralization rate of the reverse osmosis membrane device is 99% or higher.

9. The water processing system according to claim 1, wherein the electric deionization device supplies water having an electrical conductivity that is associated with the water electrolysis device.

10. The water processing system according to claim 1, wherein the ultrafiltration membrane device, the reverse osmosis membrane device, and the electric deionization device are housed in one container.

11. A water processing method that is executed by a water processing system including an ultrafiltration membrane device, a reverse osmosis membrane device, an electric deionization device, and an information processing device, the method comprising, by the information processing device, controlling operations of the ultrafiltration membrane device, the reverse osmosis membrane device, and the electric deionization device based on information on a water electrolysis device that obtains hydrogen by subjecting water to electrolysis.
